(19) United States
(12) Patent Application Publication
(10) Pub. No.: US 2015/0268920 A1
(43) Pub. Date: Sep. 24, 2015

(54) System, Software and Method of Use of an Audio Hardware Controller

(71) Applicant: Schapiro Audio LLC, West Hollywood, CA (US)

(72) Inventor: Michael Schapiro, West Hollywood, CA (US)

(73) Assignee: Schapiro Audio LLC, West Hollywood, CA (US)

(21) Appl. No.: 14/219,418

(22) Filed: Mar. 19, 2014

(51) Int. Cl. G06F 3/16

(52) U.S. Cl. CPC G06F 3/162

(57) ABSTRACT

A system, software and method of use for improved audio controls on an audio hardware controller system.

The present invention relates generally to an apparatus and method of use for an audio hardware controller system, and more particularly to an integrated user interface including a configurable multi-axis joystick for controlling an audio hardware controller system.

Mixing consoles provide a user with the ability to view, separate and integrate media data through several groups of controls for each of multiple media channels. In the case of live mixing consoles, the user needs fast access to the controls for each channel as well as the ability to synchronize events on, and between, each channel. On traditional analog mixing consoles, individual controls are grouped into functional areas, such as input, equalizer, dynamics, and auxiliary procedures. These controls may be repeated for each channel strip, which result in a large work surface as well as a complex and potentially confusing user interface.

Digital mixing consoles attempt to mitigate the problem of large and complex work surfaces by using a single channel strip approach, in which an operator selects a channel and then accesses and controls the parameters of the selected channel using a single set of dynamically updated functional controls for each of the functional areas corresponding to the currently selected channel. This avoids the need to have a dedicated set of controls for each channel.

However, joining in time or synchronizing, (“synching”) these disparate signals remains troublesome, even for very experienced users, the lack of doing so results in off-time audio effects, such as mis-timed action and audio.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY

A control apparatus for an audio processing system that performs surround sound panning includes a processor, control surface, a configurable multi-axis joystick with integrated capacitive user interface (the “joystick”), and software configured for controlling an audio hardware controller system. The processor may be a single processing unit or a network of processing units. The network may be integrated or distributed.

The joystick may be hardwired into the control apparatus or be wirelessly connected. The joystick and integrated capacitive user interface may be implemented using, for example, a capacitive material disposed around the handle of the joystick. The capacitive user interface is activated by the user's finger(s) as they trace around the handle of the joystick. A display may incorporate the position and movement of sound according to inputs from the various input devices or from recorded data. The display may include touchscreen capabilities. An operator can input data, programming or position information through a touchscreen or through one or more other input devices, such as the joystick.

The control surface may include one or more complete and separate panning sections. In one embodiment, the control surface includes two or more complete and separate panning sections. Each panning section may include a joystick, input devices, and hand or foot switches. Furthermore, the control surface may include switches that change function based on the state of the other switches in the panning section. The separate panning sections may also be linked together to process synchronized stereo tracks.

The joystick may be linked in one or more axes. In one embodiment, the joystick may be linked to one or more of the x-, y- and z-axes.

Surround panning in sound-for-picture applications often includes moving sound from one location to another over time. For example, in a motion picture, if a car passes by, or a person is walking across a room, the sound ideally would move in a similar fashion. In these cases, a sound's position has a start point and an end point. The joystick and integrated capacitive user interface enables an operator to move the location of a sound along a variable or fixed path between multiple locations in a synchronized fashion.

Another method of modifying the data track is through the use of commercial plugins. Plugins, which may be proprietary or developed by a third party, may be used to alter the sounds (in a multitude of ways) that are played through them. For example, a plugin may filter out certain frequencies; change a male voice to a female voice, or change pitch bending and distortion. Most commercial plugins have multiple parameters, each of which may change the way they affect sound. Controlling these parameters live, as the sound is playing, is currently not only a very unintuitive process but, due to physical constraints, it is also often limited to one or two parameters. This is because a user can, at most, use two knobs (and thus two parameters) at a time.

In one or more embodiments, the joystick may be comprised of two or more multi-functional joysticks. Each joystick has three axes: left/right, up/down, and twist. In an embodiment, these axes may be further defined as: left/right (X-axis), up/down (Y-axis), and twist (Z-axis). Each of these joysticks may be operated as surround panners, but they may also be independently configured to link each axis to a separate plugin parameter. Therefore, a user may independently control up to six separate parameters at a time.

One embodiment is currently a MIDI-based hardware controller with support for third party software.

In one or more embodiments the audio hardware controller may be switchable between Pro Tools™ mode and at least one MIDI modes. The at least one MIDI mode may be utilized for both low and high resolution MIDI.

In one or more embodiments, while in MIDI mode, the Mute, Solo, Skillet, Right Pan, Window, rotary, and touchscreen buttons send MIDI Note messages.

The X-Axis, Y-Axis, and Z-Axis buttons will send a random data value on their associated joystick Midi Control Change data channel (CC#), useful for linking a joystick axis to a MIDI Learn object in a virtual instrument. Sending a CC# value to Skillet Port 1, corresponding to one of the faders' current CC#'s, will move the fader correspondingly.

Similarly, sending a MIDI Note message with velocity 127 to Skillet that corresponds with the Mute, Solo, Right Pan, or Skillet buttons will turn the LED for that button on.

A MIDI Note message with velocity 0 will turn the corresponding button's LED off.

In one or more embodiments, while in MIDI mode, the default CC#'s 9-16 are as follows:

CC#09: Left Joystick X Axis

CC#10: Left Joystick Y Axis

CC#11: Left Joystick Z Axis

CC#12: Right Joystick X Axis

CC#13: Right Joystick Y Axis

CC#14: Right Joystick Z Axis

CC#15: Left Fader

CC#16: Right Fader

CC#41: Left Joystick X Axis (LSB)

CC#42: Left Joystick Y Axis (LSB)

CC#43: Left Joystick Z Axis (LSB)

CC#44: Right Joystick X Axis (LSB)

CC#45: Right Joystick Y Axis (LSB)

CC#46: Right Joystick Z Axis (LSB)

CC#47: Left Fader (LSB)

CC#48: Right Fader (LSB)

In one or more embodiments, the default may be changed by pressing the yellow right arrow from the Transport Buttons menu on the touch screen, which will enable the Settings menu. A user may select the MIDI CC Offset. The user may then move the previous list of MIDI controls in banks of 8.

In one or more embodiments, the default may be changed by pressing the yellow right arrow from the Transport Buttons menu on the touch screen, which will enable the Settings menu. A user may fully-customize the MIDI CC# by changing the MIDI CC per axis.

In one or more embodiments, the audio hardware controller may also be configured for a HUI-specification mode for Apple Logic.

In one or more embodiments the audio hardware controller may further comprise two multi-bit motorized faders to allow for control of the volume automation on two tracks.

In one or more embodiments the audio hardware controller may further comprise two rotary knobs to allow for stereo panning.

In one or more embodiments the audio hardware controller may further comprise two rotary knobs which may be linked virtually to the two faders.

In one or more embodiments the audio hardware controller may further comprise one or more hardware switches or buttons. These hardware switches or buttons may be configured to assist in controlling the following functions in Pro Tools™ mode.

In one or more embodiments the Skillet button may switch the joystick between functioning as a Surround Panner (default), and a set of 3 Virtual-Potentiometers (V-Pots).

In one or more embodiments, when activated, certain buttons will change to a pre-configured function.

In one or more embodiment, while in MIDI mode, the hardware switches or buttons may send a Note On command.

In one or more embodiment, the Pan/Skillet button may be configured to allow for pre-set combinations of joystick commands.

In one or more embodiments holding the Shift (X-Axis) button while in Surround Panner Mode, may change the function of other buttons to pre-configured alternative functions.

In one or more embodiments pressing the Shift (X-Axis) button while in Skillet Mode, pressing this button may send a special control signal to the Audio Software to facilitate parameter “learning” or “linking.”

In one or more embodiments, a footswitch may be used to lock-out touch triggers from the joysticks (the “Touch Lockout Mode”). In this mode, if a user is holding the footswitch and grabs a joystick, no pan information will be sent until the footswitch is released.

In one or more embodiments pressing the Down (Right) (Z-Axis) button may nudge the panner focus down a track. If the ‘Shift’ key is held, pressing the Down (Right) (Z-Axis) button may cycle the panner's focus through the sends on the track.

In one or more embodiments pressing the Down (Right) (Z-Axis) button may send a special control signal to the V-Pot linked to the Z axis (twist) of the joystick, for plugin knob “learning” or “linking”

In one or more embodiments pressing the Up (Left) (Y-Axis) button while in Surround/Panner Mode, may nudge the panner focus up a track. If the ‘Shift’ button is held, pressing this button may cycle the panner's focus through the sends on the track.

In one or more embodiments pressing the Up (Left) (Y-Axis) button while in Skillet Mode, may send a special control signal to the V-pot linked to the Y axis of the joystick, for plugin knob “learning” or “linking”

In one or more embodiments, the Window (Bank Up)/(Nudge Up) button will display the currently linked Pro Tools™ panner or plugin window.

In one or more embodiments, if the Shift button is held down, the left side Window (Bank Up)/(Nudge Up) button nudges the faders up by 1 track. In one or more embodiments, if the Shift button is held down, the right side Window (Bank Up)/(Nudge Up) button banks the faders up by 8 tracks.

In one or more embodiments, if the Shift button is held down, the left side Right Pan (Nudge Down) button nudges the faders down by 1 track. In one or more embodiments, if the Shift button is held down, the right side Right Pan (Bank Down) button banks the faders down by 8 tracks.

In one or more embodiments, if the Mute/Solo button is pressed it will mute/unmute, and solo/unsolo (respectively) the track associated with the fader.

In one or more embodiments, the Fader Rotaries are linked to control panning of the track associated with the fader. Additionally, in one or more embodiments, pressing the rotary will select the currently associated track in the Pro Tools™ interface.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Other objectives, features and advantages of the invention will become apparent from the following description and drawings wherein. Similar reference characters denote similar elements throughout the several views.

### BRIEF DESCRIPTION OF THE DRAWINGS

FIG. 1 is an isometric view of an embodiment of an audio hardware controller system.

FIG. 2 is a top view of an embodiment of an audio hardware controller system.

FIG. 3 is a perspective view of an embodiment of a joystick.

FIG. 4 is a schematic diagram of the process flow of an embodiment of an audio hardware controller system.

FIG. 5 is a graphical representation of an embodiment of an audio hardware controller system.

### DETAILED DESCRIPTION

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

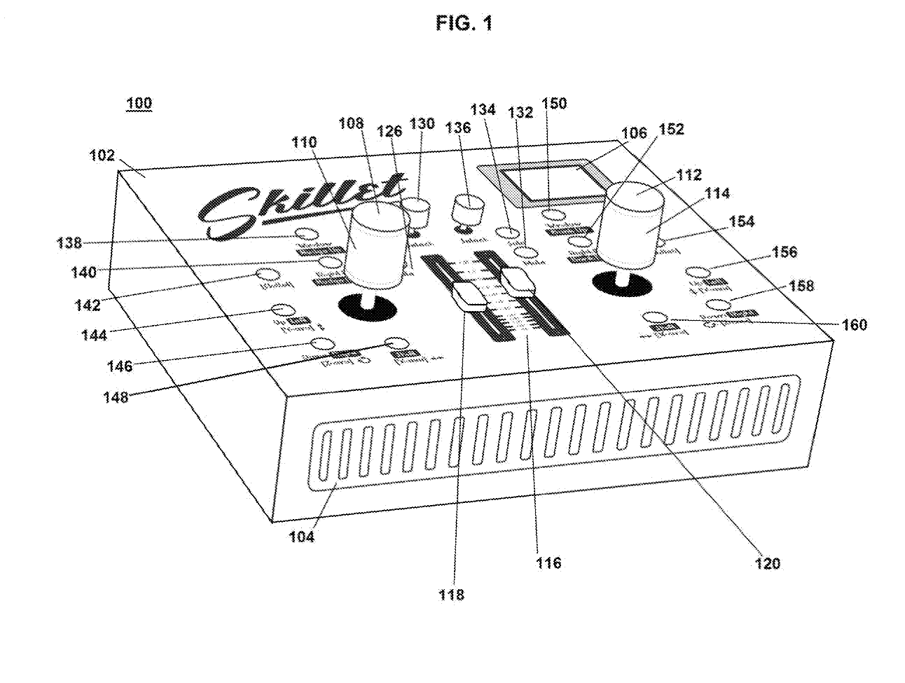

Referring now to FIG. 1, the audio hardware controller system 100 is comprised of an enclosure 102 with a means for ventilation 104. The enclosure 102 may further comprise a touchscreen 106 for input and display.

The audio hardware controller system 100 may further comprise one or more controllable touch-sensitive joysticks 108, 112.

A left joystick 108 further comprises a touch-sensitive portion 110. The left joystick 108 further comprises x- and y-axis input control, while the touch-sensitive portion 110 controls the z-axis input. A right joystick 112 further comprises a touch-sensitive portion 114. The right joystick 112 further comprises x- and y-axis input control, while the touch-sensitive portion 114 controls the z-axis input.

A fader control 116 may be comprised of one or more channels 118, 120. A left channel control 118 may be used to increase or decrease an audio level. A right channel control 120 may be used to increase or decrease an audio level. The left channel control 118 may be coupled and de-coupled to the right channel control 120.

Fader channel-specific controls: Mute 126, 132; Solo 202 (not pictured), 134; and fader rotary Select 130, 136 are configured above the fader control 116.

Left channel Mute 126 will mute or un-mute the associated track. Pressing the left Solo 202 (not pictured) will solo or un-solo the track associated with the left fader channel. In MIDI mode, pressing the left channel Mute 126 or the left Solo 202 (not pictured) will send a Note.

Left channel fader rotary Select 130 will select or de-select the left fader channel.

Right channel Mute 132 will mute or un-mute the associated track. Pressing the right Solo 134 will solo or un-solo the track associated with the right fader channel. In MIDI mode, pressing the right channel Mute 132 or the right Solo 134 will send a Note.

Right channel fader rotary Select 136 will select or de-select the right fader channel.

In Panner mode, the Window Nudge Up button 138 will hide or display the associated track's pop-up display on an attached computing device (not shown). In Panner mode, the Window Bank Up button 150 will hide or display the associated track's pop-up display on an attached computing device (not shown).

If the Left Shift button 148 or the Right Shift button 160 is depressed, the Window Nudge Up button 138 will nudge the two fader channel controls 118, 130 up one track. If the Left Shift button 148 or the Right Shift button 160 is depressed, the Window Bank Up button 150 will bank the two fader channel controls 118, 130 up eight tracks.

In Plugin mode the Window Nudge Up button 138 and Window Bank Up button 150 will display or hide the plugin's window on an attached computing device (not shown).

In MIDI mode the Window Nudge Up button 138 and Window Bank Up button 150 will send a Note.

In Panner mode, the Right Pan Nudge Down button 140, when toggled on, will cause the associated joystick 108, 112 to attach to the right-side of a stereo track. If left active with a mono track, there is no effect. When switched back to a stereo track, the associated joystick 108, 112 will link back to the right-side of the stereo track.

If the Left Shift button 148 or the Right Shift button 160 is depressed, the Right Pan Nudge Down button 140 will nudge the two fader channel controls 118, 130 down by one track. If the Left Shift button 148 or the Right Shift button 160 is depressed, the Right Pan Bank Down button 152 will bank the two fader channel controls 118, 130 down eight tracks.

In MIDI mode the Right Pan Nudge Down button 140 and Pan Bank Down button 152 will send a Note.

Left Skillet button 142 changes the Left Joystick 108 from Panner to Plugin mode when the device is in Plugin mode. If device is not in Plugin mode, Left Skillet button 142 will attempt to change device to Plugin mode. In MIDI mode, Left Skillet button 142 will send a Note.

Right Skillet button 154 changes the Right Joystick 112 from Panner to Plugin mode when the device is in Plugin. If device is not in Plugin mode, Right Skillet button 154 will attempt to change device to Plugin mode. In MIDI mode, Right Skillet button 154 sends a Note.

In MIDI mode, the Left Shift button 148 sends a random number of the same controller as the X axis, for MIDI learn.

In MIDI mode, the Right Shift button 160 sends a random number of the same controller as the X axis, for MIDI learn.

In Panner mode, the Left Up/Left/Y-Axis button 144 moves the focus of the Left Joystick 108 up one track. If the Left Shift button 148 is depressed, Left Up/Left/Y-Axis button 144 moves the focus left and onto a Send, if one is available. In plug-in mode, the Left Up/Left/Y-Axis button 144 is used for linking the Y-Axis of the Left Joystick 108 to a selected plug-in parameter. In MIDI mode the Left Up/Left/Y-Axis button 144 sends a random number of the same controller as the Y-axis, for MIDI learn.

In Panner mode, the Right Up/Left/Y-Axis button 156 moves the focus of the Right Joystick 112 up one track. If the Right Shift button 160 is depressed, Right Up/Left/Y-Axis button 156 moves the focus left and onto a Send, if one is available. In plug-in mode, the Right Up/Left/Y-Axis button 156 is used for linking the Y-Axis of the Right Joystick 112 to a selected plug-in parameter. In MIDI mode the Right Up/Left/Y-Axis button 156 sends a random number of the same controller as the Y-axis, for MIDI learn.

In Panner mode, the Left Down/RightZ-Axis button 146 moves the focus of the Left Joystick 108 down one track. If the Left Shift button 148 is depressed, Left Down/Right/Z-Axis button 146 moves the focus right and onto a Send, if one is available. In plug-in mode, the Left Down/Right/Z-Axis button 146 is used for linking the Z-Axis of the Left Joystick 108 to a selected plug-in parameter. In MIDI mode the Left Down/Right/Z-Axis button 146 sends a random number of the same controller as the Z-axis, for MIDI learn.

In Panner mode, the Right Down/Right/Z-Axis button 158 moves the focus of the Right Joystick 112 down one track. If the Right Shift button 160 is depressed, Right Down/Right/Z-Axis button 156 moves the focus right and onto a Send, if one is available. In plug-in mode, the Right Down/Right/Z-Axis button 158 is used for linking the Z-Axis of the Right Joystick 112 to a selected plug-in parameter. In MIDI mode the Right Down/Right/Z-Axis button 156 sends a random number of the same controller as the Z-axis, for MIDI learn.

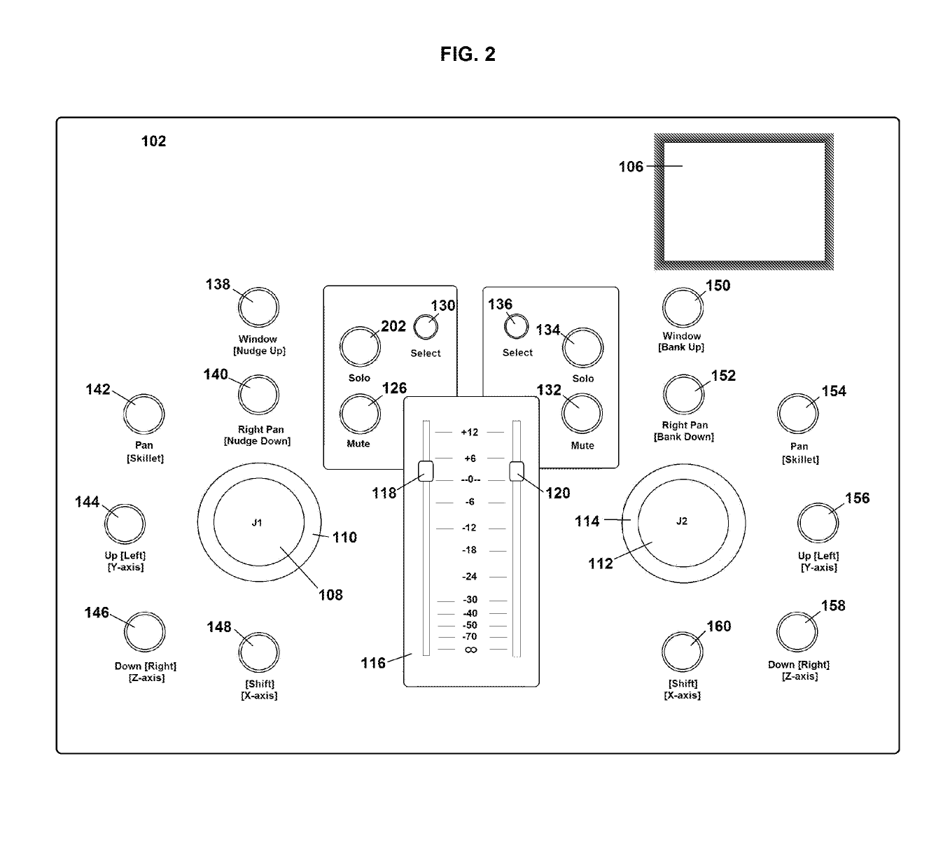

Referring now to FIG. 2, the similar reference characters in this top down view and described above from the isometric view have similar functions.

In addition, Left channel Mute 126 will mute or un-mute the associated track. Pressing the left Solo 202 will solo or un-solo the track associated with the left fader channel. In MIDI mode, pressing the left channel Mute 126 or the left Solo 202 will send a Note.

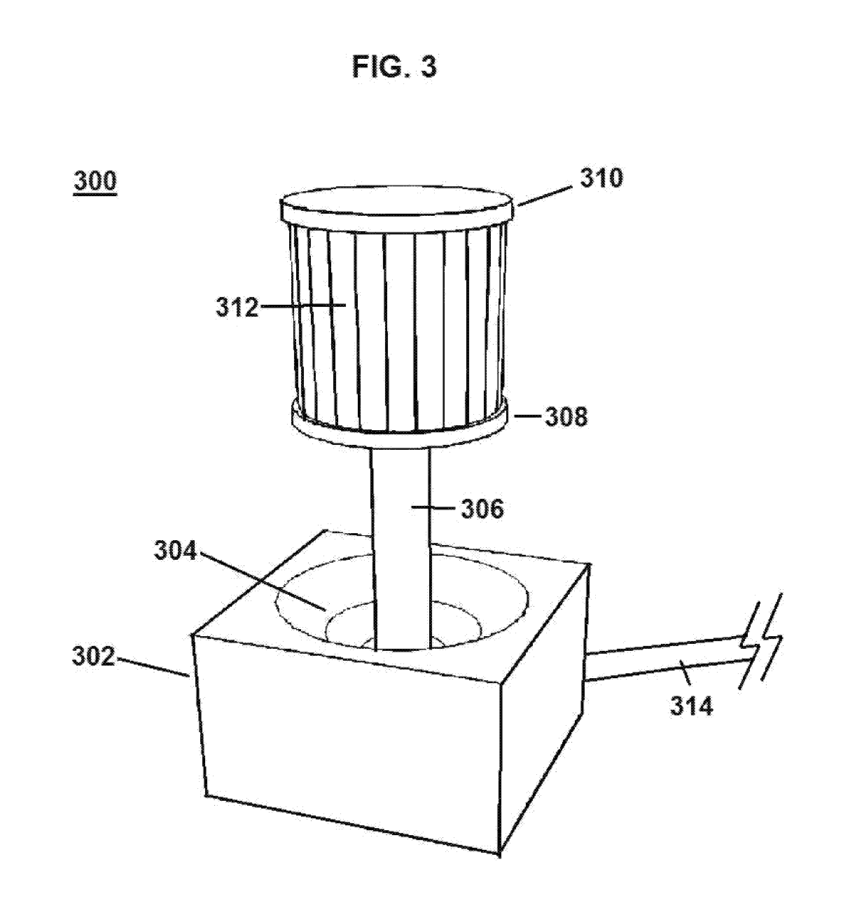

Referring now to FIG. 3, the touch-sensitive joystick 300 comprises a base 302 with a cone-shaped concavity 304 in the top surface of the base 302 to allow multiple axial movement of the shaft 306. The shaft 306 is fixedly connected to a lower handle base 308 and an upper handle base 310. A touch-sensitive region 312 is disposed between a lower handle base 308 and an upper handle base 310 and allows for conductive touch control of a configured parameter. A power and control cable 314 for external communication and power is attached to the sensors (not shown) within the base 302.

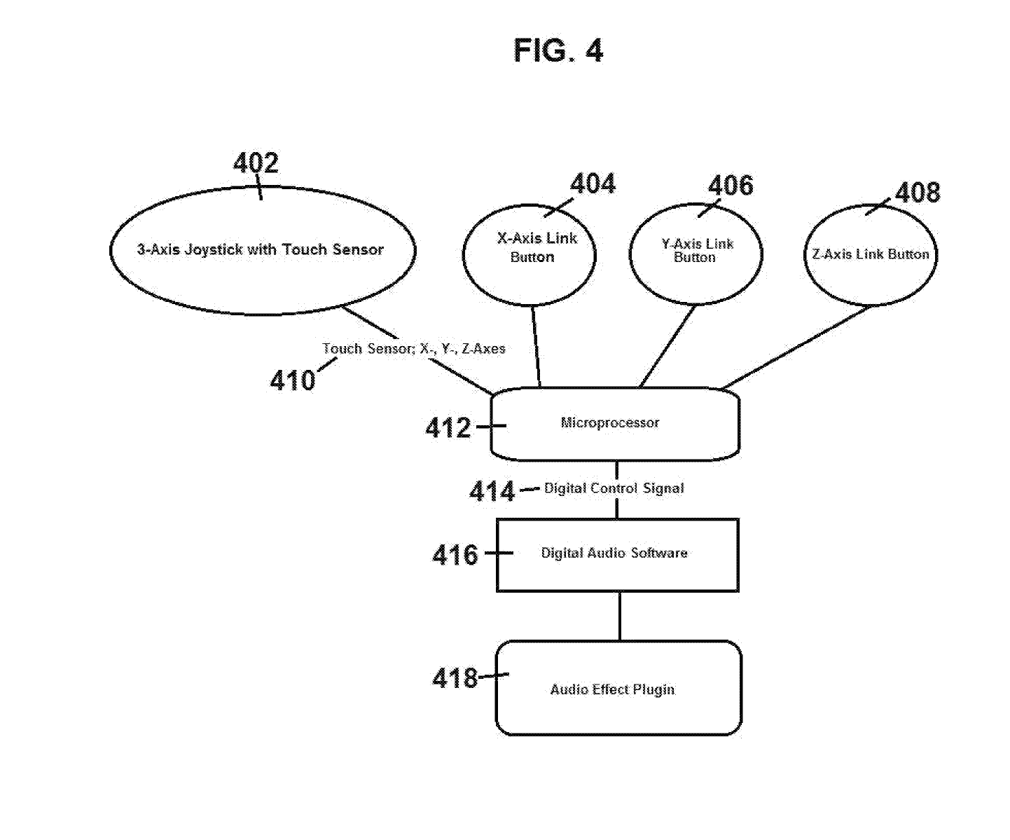

Referring now to FIG. 4, a graphical representation of the main components of the audio hardware controller system include one or more touch sensitive, multi-axis joysticks 402, an X-axis link button 404, a Y-axis link button 406, and a Z-axis link button 408. By manipulating the touch sensor 410, and one or more of the axes link buttons 404, 406, 408, a signal will be sent to the microprocessor 412. The microprocessor 412 will, in turn, send a digital control signal 414 to the digital audio software 416. The digital audio software will provide the properly formatted communication to an audio effect plug-in 418 to create the desired sound, action or effect required.

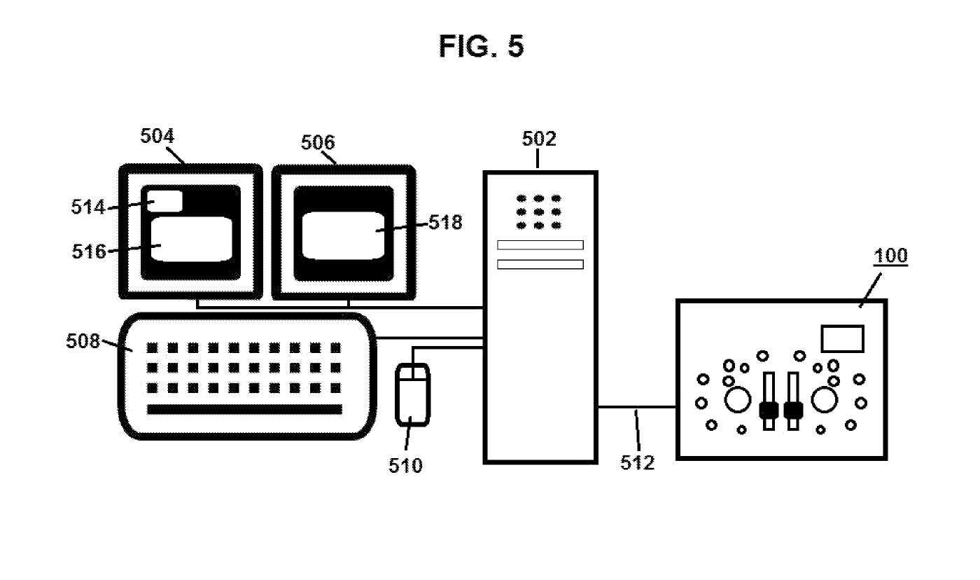

Referring now to FIG. 5, in an embodiment a computing unit 502 is communicatively coupled to one or more display monitors 504, 506, one or more user input devices, here a keyboard 508 and a mouse 510 and the audio hardware controller system 100.

The communicative coupling between the computing unit 502 and the audio hardware controller system 100 may be a universal serial bus (USB) cable 512 or other type of bi-directional communications cable.

Display monitor 504 may display the audio hardware controller system 100 status in a status window 514 and an unmodified audio/video signal in a display window 516. Display 506 may show a modified audio/video signal in a display window 518.

The configuration of the audio hardware controller system 100 may result in changes in the status window 514 and the modified audio/video signal in the display window 518.

I claim:

1. An audio hardware apparatus comprising:
a. a control surface
b. at least a first configurable multi-axis joystick with an integrated capacitive user interface,
c. at least a first user-controllable feature on the control surface wherein the one or more user-controllable features modifies the function of the at least a first configurable multi-axis joystick with an integrated capacitive user interface; and
d. a means for outputting the configuration of the at least a first configurable multi-axis joystick with an integrated capacitive user interface and the at least a first user-controllable feature on the control surface.

2. The audio hardware apparatus of claim 1 wherein the at least a first configurable multi-axis joystick with an integrated capacitive user interface further comprises two or more configurable multi-axis joysticks with integrated capacitive user interfaces.

3. The audio hardware controller system of claim 2 wherein the at least two configurable multi-axis joysticks with integrated capacitive user interfaces are configured to operate independently.

4. The audio hardware controller system of claim 2 wherein the at least two configurable multi-axis joysticks with integrated capacitive user interfaces are configured to operate in tandem.

5. The audio hardware apparatus of claim 1 wherein the at least a first user-controllable feature on the control surface further comprises two or more user-controllable features on the control surface.

6. The audio hardware apparatus of claim 5 wherein at least one of the two or more user-controllable features on the control surface further comprises a touch screen display.

7. An audio hardware controller system comprising:
a. at least a first computing unit,
b. a control surface,
c. at least a first configurable multi-axis joystick with an integrated capacitive user interface,
d. at least a first user-controllable feature on the control surface wherein the one or more user-controllable features modifies the function of the at least a first configurable multi-axis joystick with an integrated capacitive user interface; and
e. a communicative coupling means between the control surface, the at least a first configurable multi-axis joystick with an integrated capacitive user interface and the at least a first computing unit for outputting the configuration of the at least a first configurable multi-axis joystick with an integrated capacitive user interface and the at least a first user-controllable feature on the control surface.

8. The audio hardware controller system of claim 7 wherein the at least a first configurable multi-axis joystick with an integrated capacitive user interface further comprises two or more configurable multi-axis joysticks with integrated capacitive user interfaces.

9. The audio hardware controller system of claim 7 wherein the at least two configurable multi-axis joysticks with integrated capacitive user interfaces are configured to operate independently.

10. The audio hardware controller system of claim 7 wherein the at least two configurable multi-axis joysticks with integrated capacitive user interfaces are configured to operate in tandem.

11. The audio hardware controller system of claim 7 wherein the at least a first user-controllable feature on the control surface further comprises two or more user-controllable features on the control surface.

12. The audio hardware controller system of claim 7 wherein at least one of the two or more user-controllable features on the control surface further comprises a touch screen display.

13. A method for using an audio hardware controller comprising the steps of:
a. providing a control surface
b. providing at least a first configurable multi-axis joystick with an integrated capacitive user interface,
c. providing at least a first user-controllable feature on the control surface wherein the one or more user-controllable features modifies the function of the at least a first configurable multi-axis joystick with an integrated capacitive user interface; and
d. providing a means for outputting the configuration of the at least a first configurable multi-axis joystick with an integrated capacitive user interface and the at least a first user-controllable feature on the control surface.

14. The method for using an audio hardware controller of claim 13, wherein the step of providing at least a first configurable multi-axis joystick with an integrated capacitive user interface further comprises the step of providing two or more configurable multi-axis joysticks with integrated capacitive user interfaces.

15. The method for using an audio hardware controller of claim 13 further comprising the step of configuring the at least two configurable multi-axis joysticks with integrated capacitive user interfaces are configured to operate independently.

16. The method for using an audio hardware controller of claim 13 further comprising the step of configuring the at least two configurable multi-axis joysticks with integrated capacitive user interfaces are configured to operate in tandem.

17. The method for using an audio hardware controller of claim 13, wherein the step of providing at least a first user-controllable feature on the control surface further comprises the step of providing two or more user-controllable features on the control surface.

18. The method for using an audio hardware controller of claim 17, wherein the step of providing two or more user-controllable features on the control surface further comprises the step of providing at least one touch screen display.

19. A software product, comprising a non-transitory computational device-readable medium in which program instructions are stored, which instructions, when read by the at least a first processing unit, cause the audio data to be modified according to the configuration of the at least a first configurable multi-axis joystick with an integrated capacitive user interface as modified by the configuration of the at least a first user-controllable feature on the control surface.
